(19) United States
(12) Patent Application Publication
(10) Pub. No.: US 2025/0150163 A1
(43) Pub. Date: May 8, 2025

(54) SATELLITE COMMUNICATION SYSTEM USING A LUNEBURG LENS

(71) Applicant: US AIR TECH CORP, Tucson, AZ (US)

(72) Inventor: Patrick Kokou Gbele, Tucson, AZ (US)

(21) Appl. No.: 19/012,182

(22) Filed: Jan. 7, 2025

Related U.S. Application Data
(63) Continuation-in-part of application No. 17/584,718, filed on Jan. 26, 2022.
(60) Provisional application No. 63/142,973, filed on Jan. 28, 2021.

(51) Int. Cl. H04B 7/185

(52) U.S. Cl. CPC H04B 7/18515

(57) ABSTRACT

Satellite communication technology which uses Luneburg lenses. Multiple movable or fixed feed antennas disposed around the surface of the Luneburg lens may transmit or receive electromagnetic radiation with a plurality of pencil-like beam patterns to collectively form a wide beam pattern which covers a geographically large area of the sky. Such an arrangement may allow for higher gain, elimination of dead zones during satellite handover, better control of geographical area coverage, better control of transmission and reception power capability, capability of high operation power, and better control of electromagnetic radiation beam shape and polarization. Systems which include multiple Luneburg lenses may cover up to 180 degrees in elevation and 360 degrees in azimuth.

### CROSS-REFERENCES TO RELATED APPLICATIONS

This application is a continuation-in-part and claims benefit of U.S. patent application Ser. No. 17/584,718, filed Jan. 26, 2022, which is a non-provisional application and claims benefit of U.S. Patent Application No. 63/142,973, filed Jan. 28, 2021, the specification of which is incorporated herein in its entirety by reference.

### STATEMENT REGARDING FEDERALLY SPONSORED RESEARCH OR DEVELOPMENT

This invention was made with government support under Grant No. 2035186 awarded by the National Science Foundation. The government has certain rights in the invention.

### FIELD OF THE INVENTION

The present invention relates to telecommunication and radar devices and systems. More specifically, the present invention relates to telecommunication and radar devices and systems which use Luneburg lenses.

### BACKGROUND OF THE INVENTION

The following equation on Shannon-Hartley theory provides a basis for the antenna technology of this embodiment:

$$C = B {log}_{2} ( 1 + \frac{S}{N} )$$

where C is the channel capacity in bits per second, B is the bandwidth in Hertz, S and N are respectively the signal power and the noise power in Watts. A high capacity channel C is desirable for a high throughput bit rate in communications, e.g. 5G, satellite television, big data applications, Internet of things (IoT), and others. To achieve a high channel capacity, the equation shows that a large bandwidth B is desired along a large signal to noise ratio S/N, that is a large signal(S) over a small magnitude of noise (N). The Luneburg lens antenna has a native broadband characteristic which is a large bandwidth, e.g., 10-20 GHz, fulfilling an excellent bandwidth in the equation. Receiver technology that will be used with this present invention is expected to fulfil an optimum amplification of the satellite received signal(S) while applying an extremely selective and efficient filtering of the noise (N) resulting in a large S/N, thus a high (C).

### BRIEF SUMMARY OF THE INVENTION

It is an objective of the present invention to provide systems, devices and methods that allow for full coverage of a geographically large area of the sky, as specified in the independent claims. Embodiments of the invention are given in the dependent claims. Embodiments of the present invention can be freely combined with each other if they are not mutually exclusive.

The present invention relates to a satellite communication technology based on a Luneburg lens antenna. Systems of the present invention may be described as Satcom Technology of Elaborate Luneburg Lens Antenna (STELLA) systems. A full ground gateway (ground station), a terminal (relatively smaller than a ground station on a stationary or mobile platform) and a partial satellite transponder (namely, the receiver portion of the transponder and the satellite's antenna) may utilize this technology. In various embodiments, this technology may be used to facilitate 5G cellular telephone communications with satellite relays operating in low-earth orbit (LEO) and high altitude platform systems (HAPS). LEO and HAPS are solutions adopted by satellite communication operators to reduce latency. The technology in the present disclosure contributes to low latency for satellite communications, while enabling high data volume throughput and high data bit rates.

One of the unique and inventive technical features of the present invention is the arrangement of multiple feed antennas and microwave device accessories around a Luneburg lens. Without wishing to limit the invention to any theory or mechanism, it is believed that the technical feature of the present invention advantageously provides for full coverage of a geographically large area of the sky and optimized electromagnetics beam (EM) characteristics. None of the presently known prior references or work has the unique inventive technical feature of the present invention.

Furthermore, the prior references teach away from the present invention. For example, several arrays of feeds performing in receive and/or transmit of EM signals with simultaneous accessories around the main lens, accessories not limited to devices such as polarizers and sub-lenses, were not developed in prior arts. Also, a lens design performing beyond 30 dBi of gain has not been reported.

Furthermore, the inventive technical features of the present invention contributed to a surprising result. For example, a high gain of 36 dBi was obtained during the simulation for a small (72 millimeter diameter) lens. A gain increase well beyond 40 dBi is estimated with increased lens diameter. Although the result of 36 dBi was a simulated result, it is anticipated that the low tangent loss of the Zirconia and fused silica material, (less than loss tangent=0.004) will suitably achieve the level of the gain obtained during simulation.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWINGS

The features and advantages of the present invention will become apparent from a consideration of the following detailed description presented in connection with the accompanying drawings in which:

FIG. 1 shows the general layout of a microwave/terahertz satellite communication system of the present invention. Specifically, this figure depicts the main lens, the sublens (spherical shape), another type of sublens (flat, concave or other geometrical shape) and/or a polarizer, the feeds, and a microwave integrated circuit box featuring the LNA (Low Noise Amplifier) and circuits after the LNA.

FIG. 2A shows an illustration of light rays passing through a spherical lens with a homogeneous bandgap material (homogeneous permittivity material).

FIG. 2B shows an illustration of how rays are refracted within a lens that implements the Luneburg lens equation.

FIG. 3 shows a plane wave being focused to a point source via a Luneburg lens.

FIG. 4 shows a horn antenna as a feed for a Luneburg lens, and illustrates its virtual phase center.

FIG. 5 shows two zones of interest for the tuning of a horn antenna as a feed for a Luneburg lens.

FIG. 6 shows an embodiment of a satellite communication system receiver of the present invention (the microwave accessories of polarizers are excluded to avoid overcrowding the figure), including a single horn-antenna element, a secondary lens and a main Luneburg lens. With a movable horn-antenna and secondary lens, the main lens has a 180 degree aperture in both azimuth and elevation scan (and virtually 360 degree aperture in azimuth). However, the invention may use an array of feeds and the adoption of 2 main lenses (or more). The array could be enough to cover the 360/180 degrees in both azimuth and elevation. This example has a spherical shape, but other shapes (such as flat, concave, and so forth) may be possible using a transformation optics technique.

FIG. 7 shows an array of forty horn antenna elements mounted on a concave support (also shown at FIG. 1, item 4). The array is eight elements wide and five elements high in this non-limiting example and the type of feed is also non-limiting. The number of antenna elements is used in order to track multiple satellites that may be orbiting in a LEO simultaneously.

FIG. 8 shows an example of the use of a gradient refractive index (GRIN) to minimize the diffraction loss within the Luneburg lens. The shape of the GRIN element used for this non-limiting example is a diamond shape and is preferably a smooth spherical shape.

FIG. 9 shows examples of Q-band spherical Luneburg lens antennas of the present invention. The left antenna was fabricated using a ceramic material and the right antenna was fabricated using a polymer material. Other materials such as fused silica (glass) and others may be considered using the same gradient index technique.

FIG. 10 shows a schematic illustration of the circular and elliptical radiation beam patterns of STELLA systems of the present invention. An overlapping of the beams (circle or ellipse) will eliminate the voids (areas not covered by beams) between the circles or the ellipses.

FIG. 11 shows a schematic illustration of the azimuthal tracking and scanning capabilities of a STELLA system of the present invention.

FIG. 12 shows a schematic illustration of the elevational tracking and scanning capabilities of a STELLA system of the present invention.

FIG. 13 shows a schematic illustration of a two-lens STELLA system of the present invention which achieves AZ-360°/EL-170° to 180° with no moving parts or phased-array complex electronics. While a phased-array could be used (with less mini horn antenna elements) this may be disadvantageous to output power due to interference pattern technique decrease of the individual beam power.

FIG. 14 shows a chart of projected characteristics of a STELLA system of the present invention. These parameters may be accomplished using fused silica or another material using the gradient index technique.

FIG. 15 shows an example waveguide with a flared feed horn.

FIG. 16 shows a photograph of an example X-band lens measuring 12 cm in diameter next to a basketball for size comparison. This X-band lens provided a record 24.5 dBi gain during an outdoor long range measurement at an antenna measurement facility.

FIG. 17 shows plots of expected Luneburg lens gain from a cosine aperture feed of area S (expressed in wavelengths) as a function of Luneburg lens radius.

FIG. 18 shows a diagram of Transformation Optics (TO) applied to a spherical Luneburg lens to convert it into a flat geometrical shape.

FIG. 19 shows a diagram of different frequency bands of the flat geometrical shape of the aspherical Luneburg lens.

FIG. 20 shows a diagram of the integration of different frequency bands of the flat geometrical shape of the Luneburg lens into a single lens device.

### DETAILED DESCRIPTION OF THE INVENTION

Following is a list of elements corresponding to a particular elements referred to herein:
100 system
110 asymmetric Luneburg lens
120 feed antennas
130 intermediary element
140 feed antennas

In some embodiments, the present invention features a system (100) configured for satellite communication, radar, or a combination thereof. In some embodiments, the system (100) may comprise an asymmetric Luneburg lens (110). The system (100) may further comprise a plurality of feed antennas (120) coupled with the asymmetric Luneburg lens (110) so as to transmit or receive electromagnetic signals through the asymmetric Luneburg lens (110). Each of the feed antennas (120) may cover a sub-area of a continuous coverage area such that there are no dead zones in the coverage area. The feed antennas (120) may be fixed relative to the asymmetric Luneburg lens (110).

In some embodiments, the feed antennas may be movable relative to the asymmetric Luneburg lens (110). In some embodiments, the system (100) may further comprise an intermediary element (130) between the asymmetric Luneburg lens (110) and one of the feed antennas (120), or on the opposite side of the asymmetric Luneburg lens (110) from one of the feed antennas (120). In some embodiments, the intermediary element (130) may be a secondary symmetric Luneburg lens having a spherical or aspherical geometrical shape, a polarizer, a waveguide, or a combination thereof. In some embodiments, the intermediary element (130) may be configured to provide enhancement of a radiation beam characteristic, shaping, directivity, polarization control, or delivered power control.

In some embodiments, the asymmetric Luneburg lens (110) may be generated through a transformation optic technique applied to a spherical symmetric Luneburg lens. In some embodiments, the asymmetric Luneburg lens (110) is configured for transmission and reception of a plurality of frequency bands, a plurality of beam widths, or a combination thereof. In some embodiments, the plurality of frequency bands, the plurality of beam widths, or the combination thereof may be selected based on a desired application of the system (100). In some embodiments, the plurality of frequency bands may comprise L-C band, X-band, K-band, Q-band, V-band, W-band, or a combination thereof. In some embodiments, the system (100) may be configured to have instantaneous handover of a satellite from one feed antenna to another. In some embodiments, each feed antenna may be individually designed to emit a light beam radiation with a beam width between about 0 and 70 degrees. In some embodiments, the asymmetric Luneburg lens (110) may have an aspherical shape. In some embodiments, the asymmetric Luneburg lens (110) may comprise a metamaterial. In some embodiments, the metamaterial may be a single or double negative metamaterial. In some embodiments, the asymmetric Luneburg lens (110) may have a cubic shape, a diamond-shaped, a sphere-shaped unit cell, or a combination thereof corresponding to a filling ratio dictated by Effective Permittivity Medium Theory.

The present invention features a wide-coverage satellite communication system (100). In some embodiments, the system (100) may comprise an asymmetric Luneburg lens (110) generated through a transformation optic technique applied to a spherical symmetric Luneburg lens, configured for transmission and reception of a plurality of frequency bands, a plurality of beam widths, or a combination thereof. The system (100) may further comprise a first plurality of feed antennas (120) coupled with the asymmetric Luneburg lens so as to transmit or receive electromagnetic signals through the asymmetric Luneburg lens (110). The system (100) may further comprise an intermediary element (130) comprising a secondary symmetric Luneburg lens having a spherical or aspherical geometrical shape, a polarizer, a waveguide, or a combination thereof. The system (100) may further comprise a second plurality of feed antennas (140) coupled directly with the asymmetric Luneburg lens (110) so as to transmit or receive electromagnetic signals through the intermediary element (130). Each of the feed antennas may cover a sub-area of a continuous coverage area such that there are no dead zones in the coverage area. The first (120) and second (140) pluralities of feed antennas may each cover non-identical sub-areas of the coverage area. In some embodiments, the coverage area may be about 180 degrees elevation and 360 degrees azimuth.

The present invention features a Luneburg lens (110) for telecommunications or radar applications. The lens may have an aspherical asymmetrical shape configured for transmission and reception of a plurality of frequency bands, a plurality of beam widths, or a combination thereof.

In some embodiments, the present invention features a satellite communication system. As a non-limiting example, the system may include a Luneburg lens and a plurality of feed antennas coupled with the Luneburg lens so as to transmit or receive electromagnetic signals through the Luneburg lens. In preferred embodiments, each of the feed antennas covers a sub-area of a continuous coverage area such that there are no dead zones in the coverage area.

The feed antennas may be fixed relative to the Luneburg lens or movable relative to the Luneburg lens. The system may also include an intermediary element between the Luneburg lens and one of the feed antennas, or on the opposite side of the Luneburg lens from one of the feed antennas. As a non-limiting example, the intermediary element may be a secondary Luneburg lens. This secondary Luneburg lens may be an aspherical Luneburg lens. In other embodiments, the intermediary element may be a polarizer or a waveguide, i.e. a traditional or a photonic waveguide. The intermediary element may provide enhancement of a radiation beam characteristic, shaping, directivity, polarization control, or delivered power control.

In some embodiments, the system may be configured to have instantaneous handover of a satellite from one feed antenna to another. The electromagnetic signals may be in the L-C bands, X-band, K-band, Q-band, V-band, or W-band. Each feed antenna may be individually designed to emit a light beam radiation with a HPBW (Half Power Beam Width) of a pencil-shape beam of 0 degree to larger (e.g. 70 degrees) HPBW. In some embodiments, the radiation beam may have a gain greater than about 5, 10, 15, 20, 25, 30, or 35 dBi. In some embodiments, an increase of the lens size may provide a gain greater than 40 dBi, isotropic decibels.

In some embodiments, the Luneburg lens may have an aspherical shape. In other embodiments, the Luneburg lens may comprise a metamaterial. As non-limiting examples, the metamaterial may be a single or double negative metamaterial. In some embodiments, the Luneburg lens may have a diamond-shaped or sphere-shaped unit cell. As a non-limiting example, the Luneburg lens may be a Q-band frequency Luneburg lens smaller than about 10 cm in diameter. In other embodiments, the diameter of the Luneburg lens may be increased to increase the gain or to shape the beam characteristics.

In some embodiments, the present invention features a wide-coverage satellite communication system. As a non-limiting example, the system may include a first Luneburg lens; a first plurality of feed antennas coupled with the first Luneburg lens so as to transmit or receive electromagnetic signals through the first Luneburg lens; a second Luneburg lens; and a second plurality of feed antennas coupled with the second Luneburg lens so as to transmit or receive electromagnetic signals through the second Luneburg lens. In preferred embodiments, each of the feed antennas covers a sub-area of a continuous coverage area such that there are no dead zones in the coverage area. The first and second pluralities of feed antennas may each cover non-identical sub-areas of the coverage area. In some embodiments, the coverage area may be about 180 degrees elevation and 360 degrees azimuth. The present invention may also feature a Luneburg lens for telecommunications and radar applications, where the lens has an asymmetrical shape. In some embodiments, special calculation/tuning of the feeds may produce maximum plane wave magnitude with negligible loss at the opposite side of the lens antenna.

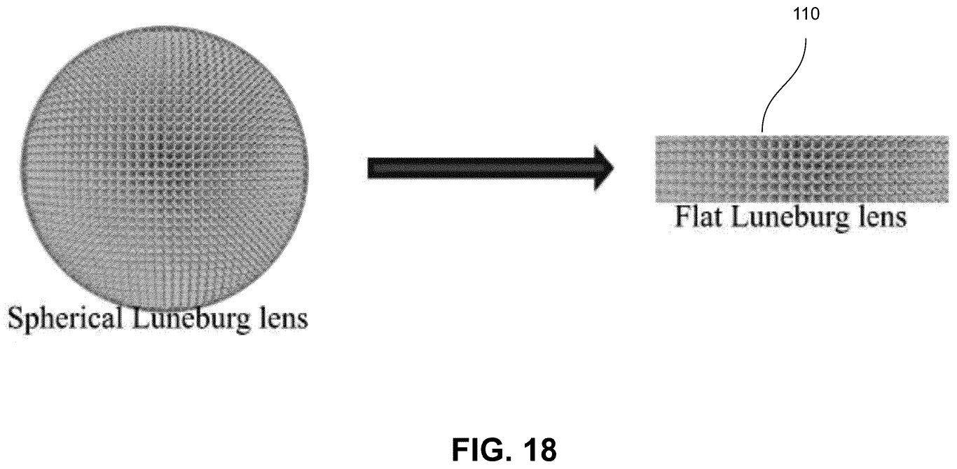

The native spherical Luneburg lens is, by essence, a symmetric device from the internal architectural design. Symmetry references are with respect to coordinate reference of the X, Y and Z axis. The X, Y and Z axis are perpendicular to each other. Luneburg lenses could be designed using different methods such as the concentric shell approach, etc. However, the EPMT (Effective Permittivity Medium Theory) also known as EMPT (Effective Medium Permittivity Theory) is the most effective that allows the application of the TO (Transformation Optics) technique to generate and change the native spherical geometrical shape of the lens. A spherical Luneburg lens could be transformed by TO into an aspherical shape, i.e., flat, concave or else geometrical shape. A trade-off with the realized gain pattern must be observed during the design. Marginal technical performances of the device are observed at certain points of the aspherical device such as at the edge of the device. A radiation gain pattern variation ensued because of transform errors at certain points of the aspherical device. The effects of aberration, diffraction, etc. are also cause of gain variation. An example of T.O. transform of spherical lens into a flat geometry is shown in FIG. 18.

The aspherical Luneburg lens offers several advantages. The control of the lens' footprint can be configured to fit a specific payload. The aspherical lens can be configured to interact with a larger number of different feed antennas. The asymmetric lens and the system incorporating said lens has increased mechanical strength. The asymmetric lens also offers the capability to add components and extend the technical features of the device because more room is available with a flat geometry than a spherical shape. The asymmetric lens also offers the important and advantageous capabilities to assemble and integrate several lens designs into one aspherical lens. For instance, the flat lens in FIG. 18 could be realized in several designs allowing different frequency bands and different beam width/shape when the unit cells of the lens are appropriately designed for the desired frequency bands and the principles of the position of the lens focus, inside, flush or outside of the lens are respected.

When the spherical Luneburg lens is transformed by TO into an aspherical shape (flat, concave or else), the device offers the advantage of integration of several designs of lenses into a single aspherical lens. The flat lens in FIG. 18 could be realized in several designs of different frequency bands and different beam widths/shapes. The different designs could be assembled in one piece of a functional Luneburg lens antenna device. The integrated aspherical lens could provide the capability of multiple frequency bands and/or multiple beam widths, simultaneously. The frequency bands of a Luneburg lens are obtained by a proper design of the unit cell, such as when using the EPMT method. The beam width (and also the radiated gain pattern of the lens) generated by a spherical Luneburg lens can be manipulated by the diameter size of the lens and/or by the position of the focal point inside, flush or outside of the lens. So, in an asymmetric Luneburg lens, different designs of the lens at desired frequencies, beam width of the radiated gain can be engineered with negligible loss (in gain) to each of the designs. When the different aspherical lenses are assembled, the aspherical Luneburg lens is no longer a symmetrical lens from the X, Y and Z axis, but instead, an asymmetrical Luneburg lens device.

In some embodiments, the array of the feed system may be controlled to produce a phased-array beam system that generates a beam from constructive and destructive beam interferences. Such a usage of the systems of the present invention would be in some ways similar to a phased-array antenna and a flat panel antenna made from microstrip antenna.

Embodiments of the present invention include antenna systems having frequency band designs that operate in the L-C, X, Q, V, and W frequency bands (0.7 MHz to 110 GHz) and extend to the terahertz frequency bands. The microwave/terahertz embodiments may operate on non-coherent light emission (i.e., not microwave amplification by simulated emission of radiation (MASER)). The high frequencies of Q, V and W bands enable high throughput data volume and high throughput data bit rates, Data throughput capabilities increase as frequency increases.

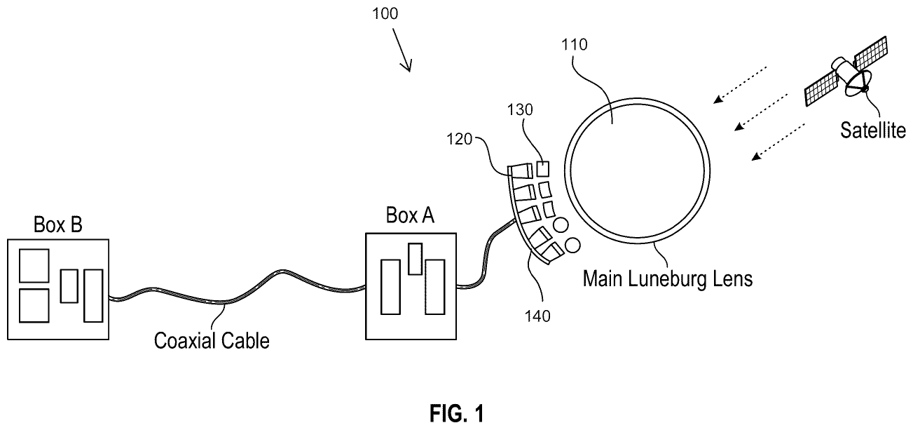

A spherical main Luneburg lens antenna is shown in FIG. 1. One or more spherical secondary lenses may be used in conjunction with the main Luneburg lens. One or more secondary lenses that are flat, convex, or hemispherical using conformal transformation optics may be alternatively used in lieu of the spherical lenses, in order to accommodate design integration. Feedhorns may be used directly with the main lens (no secondary lens configuration) or with the secondary lens. The number of feedhorns may match the number of secondary lenses. In cases where the number of feedhorns is less than the number of secondary lenses, one or more of the secondary lenses may be mounted on a gimbal so as to be movable from one feedhorn to the next feedhorn.

The satellite communication system may include antenna scanning aperture angles that are 180 degrees in elevation and virtually 360 degrees in azimuth utilizing a wideband Luneburg lens system. The antenna may be capable of simultaneous multi-beam with extremely low diffraction loss (optimized GRIN). The antenna may be 3D printed out of a polymer, Zirconia ceramic, or fused silica (glass) material and may have excellent radiation beam pattern characteristics in terms of equivalent/effective isotropic radiated power (EIRP), narrow half power beam width (HPBW), very low cross polarization, and other characteristics. Zirconia and glass each have an extremely low loss tangent, a high temperature resistance, and can operate with power beyond 500 Watts.

The satellite communication system components include the main Luneburg lens, the gradient-index (GRIN) design of the Luneburg lens unit cell to minimize the diffraction loss, the focusing secondary lenses (spherical, flat, or other shape using conformal transformation optics), a metamaterial (MTM) approach to improving the main and the secondary lenses' electromagnetic (EM) radiation pattern characteristics, an array of feedhorn antenna (corrugated, special design, or standard) elements mounted on a concave nonmagnetic support espousing partially the main Luneburg lens spherical shape, a gimbal mount supporting the nonmagnetic housing of the feedhorn, and the gimbal design to enable the array of feedhorns to rotate in limited short distance motion around the main Luneburg lens in elevation and azimuth for scanning via physical motion (motionless scanning may be accomplished without a movable gimbal). The gimbal design may allow for three degrees of axial freedom. A MTM approach may be used depending on its impact on the lens GRIN, the control/narrowing of the HPBW of the main lens, the wave bending to point from the lens to the feedhorn and also to further decrease the diffraction loss.

The software employed for satellite tracking may be simpler than similar software because of the detection capability of the Luneburg lens antenna. The tracking may use the two-line element (TLE) and be more robust than current tracking software.

The number of antenna elements is used in order to track multiple satellites that may be orbiting in a LEO simultaneously. In another embodiment where a geostationary satellite, or MEO (Medium Earth Orbit) is employed, a single horn element may be sufficient. The feedhorn elements in the array may have variable frequency bands covering the entire frequency band capability of the Luneburg lens, i.e. X-band frequency 8-12 GHz with extended operation to 20 GHz as demonstrated by M Liang, WR Ng, K Chang, K Gbele, ME Gehm, H Xin (IEEE Transactions on Antennas and Propagation 62 (4), 1799-1807).

GRIN refers to variation of the refractive index within a medium through the use of different thicknesses of the same material, the use of different materials in the propagating medium, or a combination thereof. A variable filing ratio of polymer, glass or zirconia material is shown. The center of the spherical Luneburg lens has a larger diamond unit cell (seen to the right) and the outer edge has a smaller unit cell (seen to the left). The unit cells in between correspond to intermediate forms.

The diamond designs depicted herein may be more efficient than other designs (e.g., using cubes). With this diamond design, each face of a cube is essentially pushed outwards with a respective set of four trapezoidal faces, thereby increasing the surface area. Variations on this design may be employed in other embodiments with all edges of the trapezoidal faces rounded off to eliminate sharp edges. Sharp edges may cause electromagnetic wave propagation singularity with important diffraction loss effect. Reducing sharp edges may significantly improve the gain of the lens. The GRIN of FIG. 8 minimizes the diffraction loss through the diamond shape and the lack of connecting rods as the cell-to-cell connection is made by the contact between each diamond and the neighboring diamonds.

### Antenna Design:

The antenna system addresses: elimination of dead zones during satellite handover, better control of size of geographical area of coverage by the satellite to Earth emitted light or by the ground station to the sky, better control of transmission and reception power capability, capability of high power of operation (i.e. over 500 W), better control of EM (Electromagnetics) radiation beam shape, (i.e. for defense applications), polarization (i.e. defense applications) and higher gain.

When mounted on a ground Satcom (Satellite communication) system, (i.e. ground terminal, gateway, or receiver system) antennas of the present invention may provide full coverage of a geographically large area of the sky. The feed system may be designed to cover up to 180 degrees in elevation and 360 degrees in azimuth. Such large coverage of the sky may be accomplished via a 2 or 3 lens antenna assembled on a fixed or movable support.

Antennas operating in L-C bands, X-band, K-Band, Q-band, V-band, or W-band may be designed with a traditional spherical shape or with an aspherical shape, and may be fabricated with natural or non-natural materials. Natural materials include various types of polymers, glass, and ceramics. Non-natural types of material include metamaterials, synthetic materials, single or double negative (SNG, DNG) materials, etc.

For the Q-band design with a traditional spherical shape, the diameter may be as small as 7.0 centimeters or 70.0 millimeters. This diameter may be increased up to a basketball size (or up to a diameter size where gain flattening occurs) for the purpose of increasing the radiation beam pattern gain of the lens antenna and/or to shape the beam pattern.

When mounted on an in-orbit satellite, antennas of the present invention may provide custom shape design of the radiation pattern, including all the antenna capability in polarization control. Custom shapes may be obtained by a combination of feedhorn configuration, feedhorn beam pattern design and an electronic manipulation of the overall emitted light (waveform manipulation) by the antenna system. Radiated EM (Electromagnetic) wave beams custom shape designs may be also produced by simple configuration of the feedhorn antenna's beams to overlap and form a simplistic geometrical shape of interest.

When used for 5G mobile phone applications, antennas of the present invention may efficiently eliminate dead zones of coverage (bad reception angles from the tower). The power capability may increase the reception level so as to avoid dropped calls. The many antenna feed capability combined with the high microwave frequency, i.e. K or Q-band may provide high data bit rate speed and high data bandwidth in 1000s of Gigabits/s (Terabit/s). These speeds and bandwidths meet the 5G requirements for both data speed and bandwidth.

### Antenna Feed System:

The new antenna feed system may include multiple small waveguide antennae. The waveguide antenna designs may include various types of horn antennae. Non-limiting examples of horn antennae variations include rectangular, conical, exponential, etc.

The small feed antennas may be mounted in an array on a concave non-metallic material support. The support may preferably be transparent to the EM (Electromagnetics) wave at the operating frequency. The number of feed antennas could range from 2 to more than 48 depending on the application, the EM radiation beam shape, the operating frequency, and the sky coverage size of interest. The spacing of the antennas in the array may be calculated to optimize the performance of the feed and overall antenna system. The spacing of the feedhorns has considerations that include the frequency band of operation. Higher frequency calls for physically smaller devices and more feedhorn devices to package. Cross interference/cross-talk between the feedhorns and the harmonic frequencies behavior in the lens are parameters to carefully consider during the spacing design.

### Unit Cell:

When the current invention is used with the traditional spherical lens shape, the new unit cell design may have the form of a diamond and/or sphere (ball) to minimize the incident EM wave scattering and improve the wave S-Parameters in transmission S21. As explained above, sharp edges are a cause of many losses that include diffraction loss and losses due singularities observed at sharp edges or on a tip point shape. A spherical shape (ball) unit cell is an ideal shape to pursue.

The connections between the diamond may be realized by the extension of the exposed extreme edge of the diamond to eliminate the introduction of connecting ‘stick’ and improve the exact replication of the calculated effective permittivity (|ε̅_̅{̅e̅f̅f̅}̅|̅ε̅_̅{̅e̅f̅t̅}̅) during the fabrication. In an aspherical lens shape, the unit cell may have either diamond, ball, or planar-like shape. The aspherical lenses may be designed with natural or synthetic materials, (i.e. metamaterials).

### Arrangement of Two Lenses to Cover the Whole Sky:

An arrangement of two lenses may be designed to cover the whole sky. However, 2 or more lenses may be arranged in a single system depending on lens' shape (spherical or aspherical), natural material or metamaterial, and specific application type, (i.e. maritime or aviation applications with a moving platform). Aspherical lens shapes may have more than 4 lenses depending on the applications pursued. As a non-limiting example, applications may require multiple beams with various beam technical characteristics such as beam width, polarization, sidelobe levels and many more other beam requirements.

Matching of the Design of the Feeds to their Lenses:

The feed antennas may include various types of horn antennas such as scalar horn (simple or corrugated), conical horn, dual mode horn, pyramidal horn, or ridged rectangular horn. The design appropriately matches the feed antenna to the main lens, or to the secondary lens in systems with secondary lenses. The precedent list of horn antennas may be simulated along with a Luneburg lens antenna in order to examine how well the wave phase center is matching to the lens focus, the outgoing beam width from the lens, the mode from the horn (TEM, TE or TM). Depending on the applications and the technical requirements, the appropriate horn antenna may be selected. For instance, a simple conical horn antenna produced during a simulation of a Q-band lens at a center frequency of 41.5 GHz with the lens modeled to a circular aperture of area S=0.66|λ̅²̅ (lambda is the wavelength at 41.5 GHZ=7.22 mm), 68 degree beam width, and a radiation beam pattern for up to 36 dBi, as shown in FIG. 17.

### Non-Spherical Lens Shapes:

Aspherical shaped lenses may accommodate both the device footprint of interest and EM radiation beam pattern characteristics requirements. A secondary lens positioned between the feed antenna and the main lens may adopt an aspherical shape as needed. Aspherical shapes include flat, concave, hemispherical, mixed flat-concave and freeform shapes.

Use of Metamaterials with Negative Refractive Index:

A metamaterial is a synthetic material which is not found among natural materials. As a non-limiting example, metamaterials with negative refractive index properties produce reflection and refraction that do not follow Snell's law of reflection/refraction. Examples of metamaterials are abundant in literature and could be classified in 3 main categories: (1) plasmonic metamaterials each based on a particular arrangement of subwavelength mixture of a dielectric material and a metal material; (2) photonic metamaterials obtained by a subwavelength periodicity arrangement of the constitutive unit-cells of the structure; and (3) chiral metamaterials. A metamaterial may be produced by the preceding techniques of mixing materials, shaping (geometrical shape) and/or arranging subwavelength unit-cells. The arrangement modifies the reflection and refraction of the EM wave, and subsequently the radiated beam pattern characteristic can be manipulated as desired in its width, directivity and polarization.

System Management with Intermediary Elements:

There are various possible designs for the antenna systems of the present invention. In some designs the EM wave is directly delivered between the Luneburg lens and the feed antenna. In other designs, the EM wave passes through one or more intermediary elements between the Luneburg lens and the feed antenna. Non-limiting examples of intermediary elements include a secondary Luneburg lens, a polarizer and/or a waveguide (photonic waveguide or traditional waveguide). In some designs, one or more intermediary elements may be positioned on the opposite side of the Luneburg lens from the feed antenna such that the Luneburg lens is in line between the intermediary element or elements and the feed antenna. These intermediary elements between the feed antenna and main lens, and/or after the main lens may provide enhancement of the radiation beam characteristics, shaping, directivity, polarization control, and/or control of delivered power.

### EXAMPLES

The following are non-limiting examples of the present invention. It is to be understood that said examples are not intended to limit the present invention in any way. Equivalents or substitutes are within the scope of the present invention.

### Example 1: Feed Matching to Optimize Gain

A perfect spherical lens with homogeneous refractive index has focal length that is dependent on the distance from the center of the lens. The following procedures (including the use of the proper and efficient calculations) to deliver optimum gain results could be easily executed by a person having ordinary skill in the art (i.e. a fairly trained microwave engineer). Matching the phase center of the feed to the focal point of the lens to deliver an optimum plane wave at the opposite side of the lens when a point source is applied to a side and (vice versa) producing a point source on opposite side when a plane wave is collected from the other side are the basis of the Luneburg lens equation.

The focal point of the lens could be located from design at any desired point inside, at the surface of the lens or outside of the lens. The engineer designer knows where he/she has constrained the focal point location. The procedure explained here offers a general approach to match the focal point of the lens to the phase center of the feed. Systematic methods have been published in the literature to analytically calculate the phase center and the matching error to another point of interest. However, the procedures proposed here are fairly simple and involve numerical and experimental based methods.

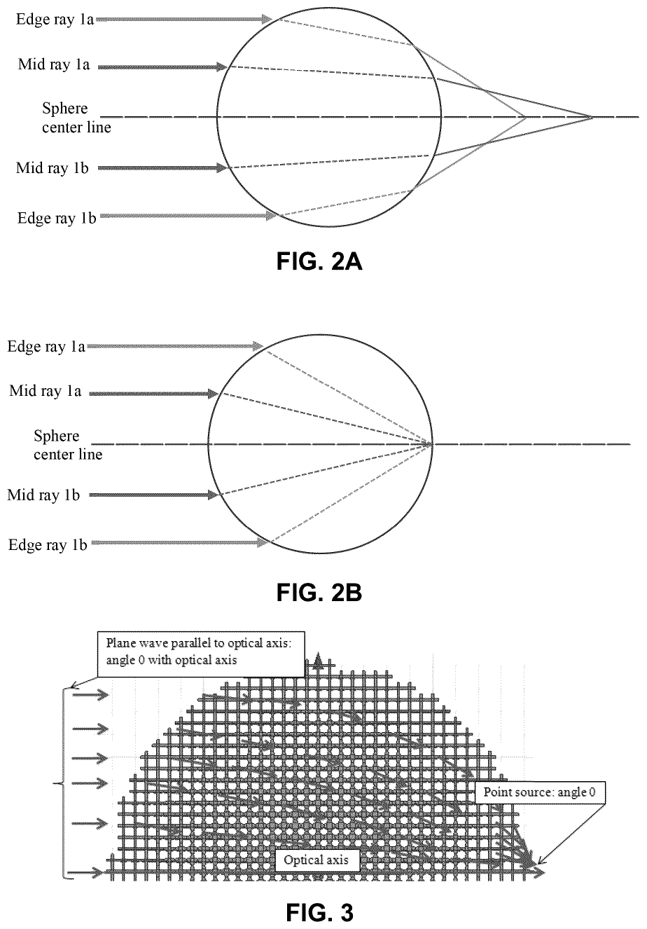

FIG. 2A shows a spherical lens with an homogeneous bandgap material that passes through light rays. The lens has a refractive index that is the same at every point of the sphere. It is noted that the edge rays 1a and 1b focal point is closer to the sphere center than the focal point of mid rays 1a and 1b. The later rays (Mid ray 1a and 1b) focal point is farther to the sphere center.

FIG. 2B shows the cartoon of how rays are refracted within a lens that implements the Luneburg lens equation. All the rays from the lens left side gather into a single point to the right of the lens.

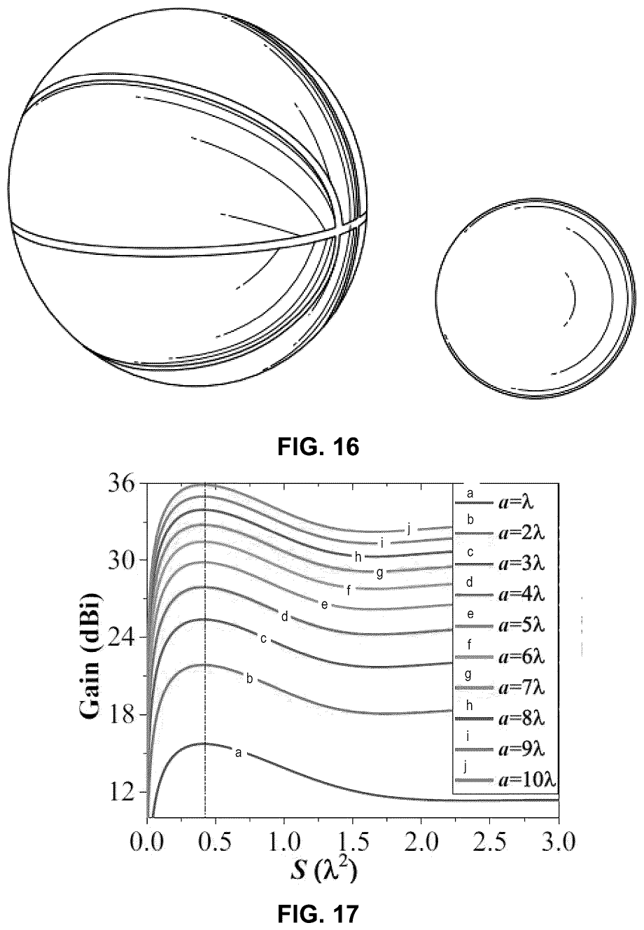

The bending of the light through the lens has a better illustration in FIG. 16 where a plane wave from the left side of the sphere is turned into a point source on the opposite side of the sphere.

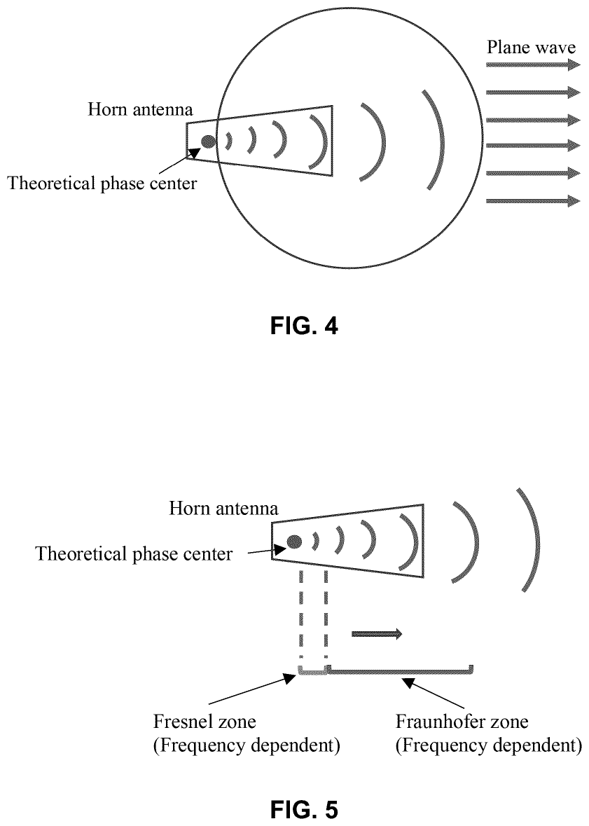

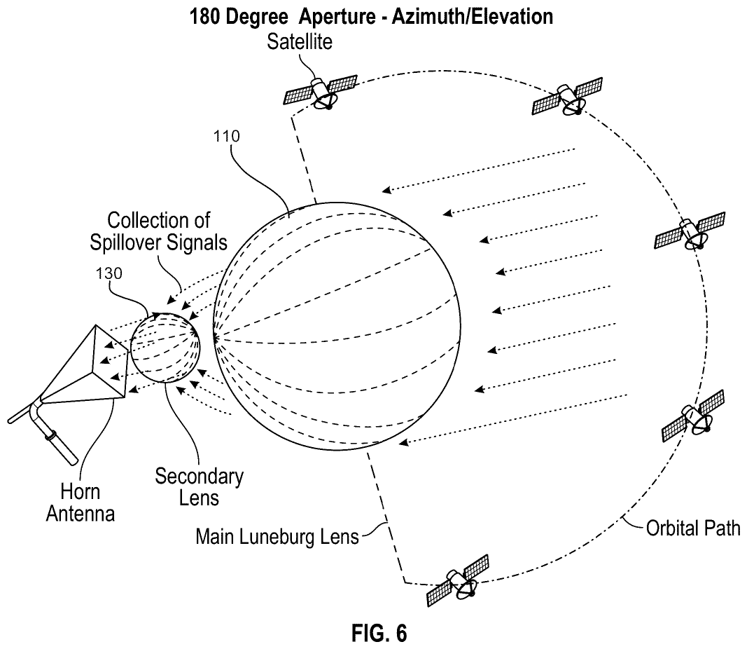

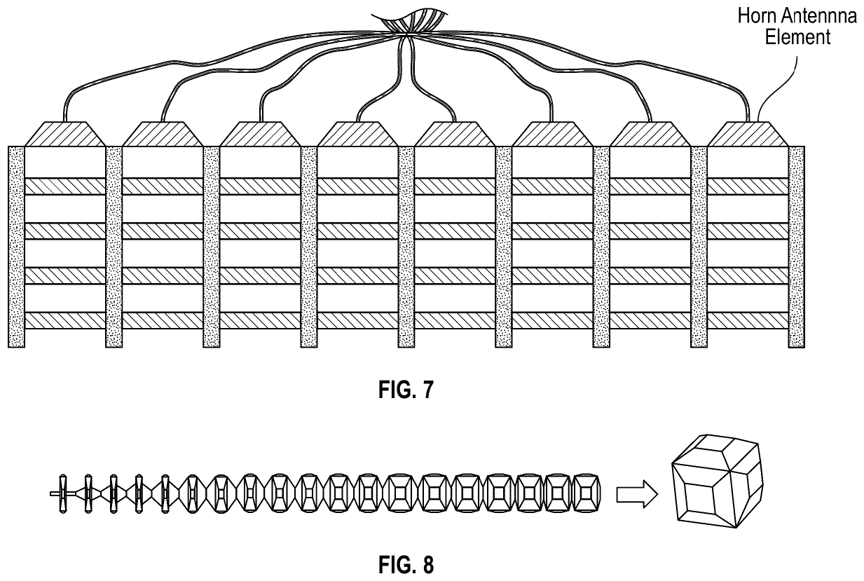

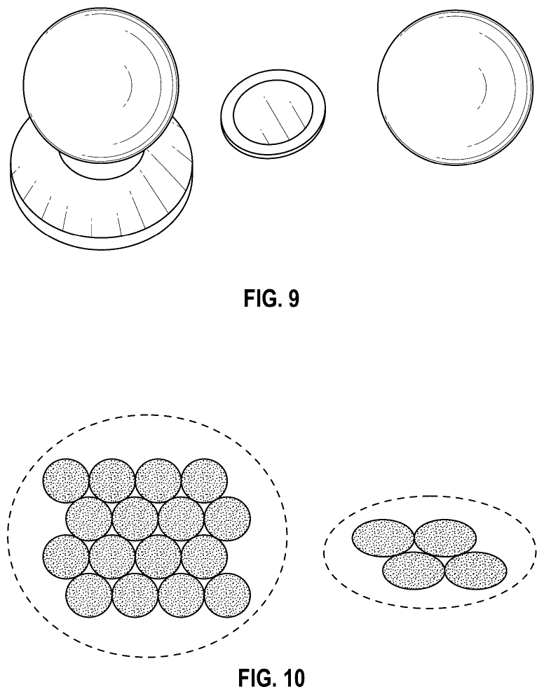

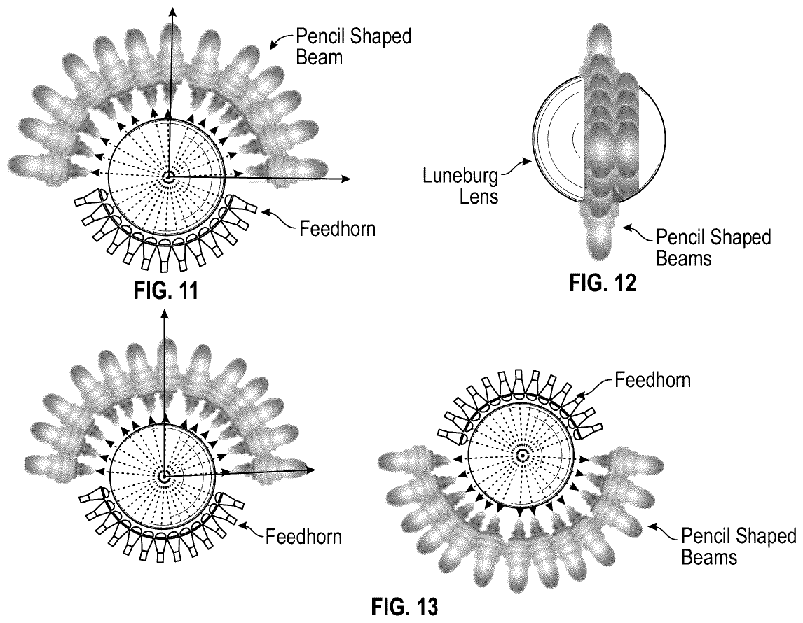

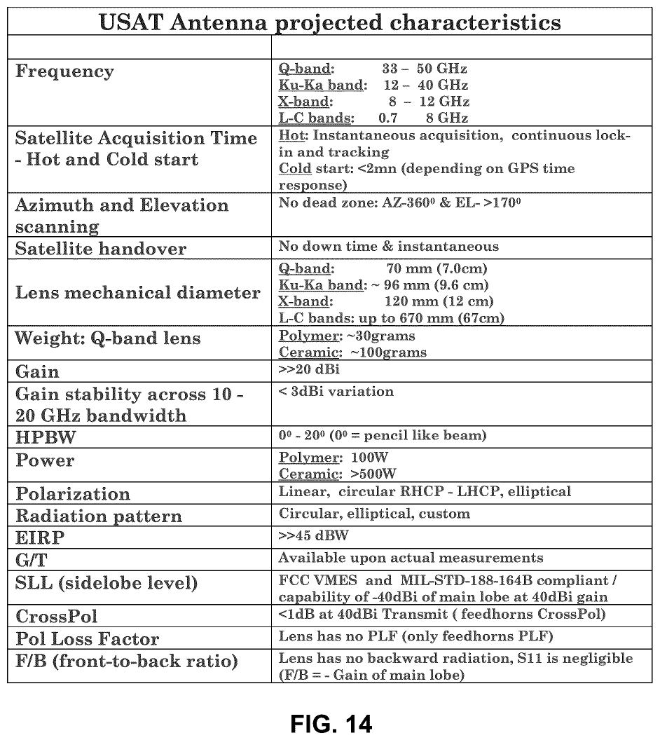

FIG. 4 presents a horn antenna as a feed and its virtual phase center. The virtual phase center of the feed should match the focal point of the lens. With parabolic reflector, such matching must be conducted to optimize the gain of the reflector antenna.

FIG. 5 shows 2 zones of interest of the tuning that must take place preferably numerically and experimentally. The matching should be around the point source or the virtual phase center and before the far-field zone known as the Fraunhofer zone. The determination of these zones is frequency dependent.

To perform the numerical matching, the virtual phase center of the feed is first numerically determined. This point could also have been provided by the manufacturer of the feed. Then the simulation of the gain pattern is performed using any preferred electromagnetics computing software, i.e. Ansys HFSS. The read off of several simulation results will provide the best matching of the phase center to the focal point of the lens sphere.

Once the simulation step is completed, the experimental step should be performed to validate the results. Fine tuning of the position of the feed to the lens sphere could be necessary and should not turn into a long process with a trained microwave engineer.

The optimum gain magnitude result is of course not only dependent on the matching of the virtual phase center to the focal point of the sphere but also to the various parameters of the GRIN (Gradient Refractive Index) of the lens. The importance of designing a GRIN of low loss was already presented in FIG. 8 and previously explained in the technical detail of the GRIN.

### Example 2: Horn Antenna Waveguide with Q-Band Frequency (33-50 GHZ)

The following example provides the design for a horn antenna waveguide at Q-band frequency, that is from 33-50 GHz. This example provides a basic design process for this waveguide and explains the wave generated from the device external to the system. The device generating the wave is a BUC (Block Upconverter) and the wave is passed to the system at the horns. The wave enters at the horn and exits either at the main lens or devices that are after the main lens.

In transmission mode, for instance, the feedhorn antennas in FIG. 1 and FIGS. 4-5 receive the light radiation from the BUC (Block Upconverter) in Box A of FIG. 1. The light signal received by the feedhorn antennas is re-emitted from the feedhorns and passes through intermediary devices (130) of FIG. 1, which may comprise polarizers positioned before or after the main lens (110) of FIG. 1. The re-emitted light travels through the main lens and finally to space passing through another mini lens/polarizer depending on the configuration of interest. The configuration of interest takes in account the desired beam characteristics (beam shape, directivity, beam polarization).

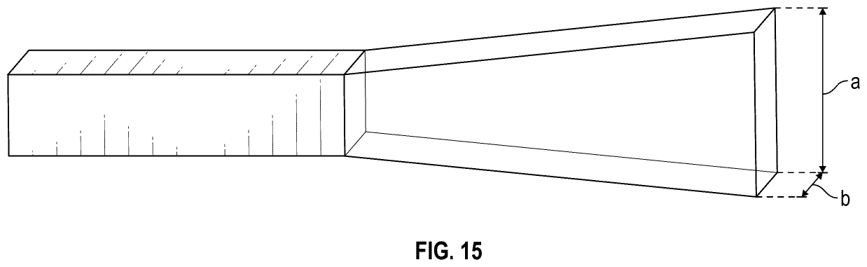

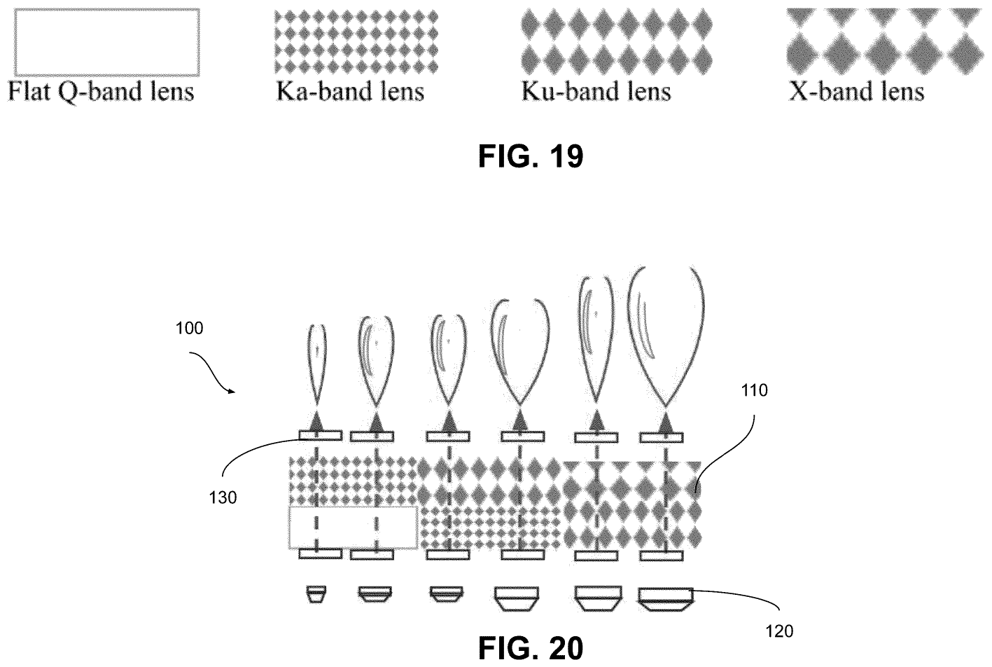

An example of a feed horn at Q-band frequency is a WR-22 waveguide operating from 33 GHz to 50 GHz. The example waveguide WR-22 with a flare (horn) for this example frequency band 33-50 GHz could be realized by calculating the size (a) FIG. 19 of the device at the end of the flare. The size (a) FIG. 15 determines the cutoff frequency |f̅_̅{̅c̅}̅|f̅_̅{̅c̅}̅ of the waveguide.

$${w}_{c} = \frac{1}{\sqrt{με}} \sqrt{{( \frac{m π}{a} )}^{2} + {( \frac{n π}{b} )}^{2}}$$

$${w}_{c} = \frac{1}{\sqrt{με}} \sqrt{{( \frac{m π}{a} )}^{2} + {( \frac{n π}{b} )}^{2}} ,$$

|w̅_̅{̅c̅}̅|w̅_̅{̅c̅}̅ is the cutoff frequency with respect to the propagating modes in the waveguide, |μ̅|μ̅ is the permeability of the material (air in this example), |ε̅|ε̅ is the permittivity, m and n are the propagation mode numbers, a and b are the sizes of the rectangular aperture of the horn shown in FIG. 15.

In this example, the cutoff frequency is |f̅_̅{̅c̅}̅|f̅_̅{̅c̅}̅=33 GHz and for a fast determination of the size (a) results in

$$\text{?}$$

$$\text{?} \text{indicates text missing or illegible when filed}$$

where the size (a) FIG. 15 can be found by extracting (a) from the equation

$$\text{?}$$

$$\text{?} \text{indicates text missing or illegible when filed}$$

|c̅|c̅ to the speed of light in free space. The size of the example (a) FIG. 15 is 4.54 mm. The size of (b) can be found by extracting b from the equation above.

As used herein, the term “about” refers to plus or minus 10% of the referenced number.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A system (100) configured for satellite communication, radar, or a combination thereof, the system (100) comprising:
a. an asymmetric Luneburg lens (110); and
b. a plurality of feed antennas (120) coupled with the asymmetric Luneburg lens (110) so as to transmit or receive electromagnetic signals through the asymmetric Luneburg lens (110);
wherein each of the feed antennas (120) covers a sub-area of a continuous coverage area such that there are no dead zones in the coverage area.

2. The system (100) of claim 1, wherein the feed antennas (120) are fixed relative to the asymmetric Luneburg lens (110).

3. The system (100) of claim 1, wherein the feed antennas are movable relative to the asymmetric Luneburg lens (110).

4. The system (100) of claim 1, additionally comprising an intermediary element (130) between the asymmetric Luneburg lens (110) and one of the feed antennas (120), or on the opposite side of the asymmetric Luneburg lens (110) from one of the feed antennas (120).

5. The system (100) of claim 4, wherein the intermediary element (130) is a secondary symmetric Luneburg lens having a spherical or aspherical geometrical shape, a polarizer, a waveguide, or a combination thereof.

6. The system (100) of claim 4, wherein the intermediary element (130) is configured to provide enhancement of a radiation beam characteristic, shaping, directivity, polarization control, or delivered power control.

7. The system (100) of claim 1, wherein the asymmetric Luneburg lens (110) is generated through a transformation optic technique applied to a spherical symmetric Luneburg lens.

8. The system (100) of claim 1, wherein the asymmetric Luneburg lens (110) is configured for transmission and reception of a plurality of frequency bands, a plurality of beam widths, or a combination thereof.

9. The system (100) of claim 8, wherein the plurality of frequency bands, the plurality of beam widths, or the combination thereof are selected based on a desired application of the system (100).

10. The system (100) of claim 8, wherein the plurality of frequency bands comprises L-C band, X-band, K-band, Q-band, V-band, W-band, or a combination thereof.

11. The system (100) of claim 1, wherein the system (100) is configured to have instantaneous handover of a satellite from one feed antenna to another.

12. The system (100) of claim 1, wherein each feed antenna is individually designed to emit a light beam radiation with a beam width between about 0 and 70 degrees.

13. The system (100) of claim 1, wherein the asymmetric Luneburg lens (110) has an aspherical shape.

14. The system (100) of claim 1, wherein the asymmetric Luneburg lens (110) comprises a metamaterial.

15. The system (100) of claim 14, wherein the metamaterial is a single or double negative metamaterial.

16. The system (100) of claim 1, wherein the asymmetric Luneburg lens (110) has a cubic shape, a diamond-shaped, a sphere-shaped unit cell, or a combination thereof corresponding to a filling ratio dictated by Effective Permittivity Medium Theory.

17. A wide-coverage satellite communication system (100) comprising:
a. an asymmetric Luneburg lens (110) generated through a transformation optic technique applied to a spherical symmetric Luneburg lens, configured for transmission and reception of a plurality of frequency bands, a plurality of beam widths, or a combination thereof;
b. a first plurality of feed antennas (120) coupled with the asymmetric Luneburg lens so as to transmit or receive electromagnetic signals through the asymmetric Luneburg lens (110);
c. an intermediary element (130) comprising a secondary symmetric Luneburg lens having a spherical or aspherical geometrical shape, a polarizer, a waveguide, or a combination thereof; and
d. a second plurality of feed antennas (140) coupled directly with the asymmetric Luneburg lens (110) so as to transmit or receive electromagnetic signals through the intermediary element (130);
wherein each of the feed antennas covers a sub-area of a continuous coverage area such that there are no dead zones in the coverage area, and
wherein the first (120) and second (140) pluralities of feed antennas each cover non-identical sub-areas of the coverage area.

18. The system (100) of claim 17, wherein the coverage area is about 180 degrees elevation and 360 degrees azimuth.

19. A Luneburg lens (110) for telecommunications or radar applications, wherein the lens has an aspherical asymmetrical shape configured for transmission and reception of a plurality of frequency bands, a plurality of beam widths, or a combination thereof.
